(19) United States
(12) Patent Application Publication
(10) Pub. No.: US 2014/0028559 A1
(43) Pub. Date: Jan. 30, 2014

(54) PROJECTOR DEVICE AND METHOD FOR CONTROLLING A PROJECTION SCREEN

(71) Applicant: CHI MEI COMMUNICATION SYSTEMS, INC., New Taipei (TW)

(72) Inventor: HSIN-WEI WANG, New Taipei (TW)

(73) Assignee: CHI MEI COMMUNICATION SYSTEMS, INC., New Taipei (TW)

(21) Appl. No.: 13/869,790

(22) Filed: Apr. 24, 2013

(30) Foreign Application Priority Data
Jul. 26, 2012 (TW) 101126989

(51) Int. Cl. G06F 3/0354

(52) U.S. Cl. CPC G06F 3/03543
USPC 345/163

(57) ABSTRACT

In a method for controlling a projection screen using a projector device, the method builds a datasheet comprising a relationship between a mouse icon and a mouse operation, and triggers a camera to capture an image of the projection screen comprising a user interface projected from the electronic device onto the projection screen, and obtains the image of the projection screen from the camera. The image of the projection screen is used to obtain a position of the mouse icon in the image of the projection screen, and a mouse operation corresponding to the mouse icon is queried. The queried mouse operation is performed on the projector device according to the obtained position of the mouse icon, and an image of the queried mouse operation is projected from the projector device onto the projection screen.

### BACKGROUND

1. Technical Field

The embodiments of the present disclosure relate to display screen controlling systems and methods, and more particularly to a projector device and method for controlling a projection screen.

2. Description of Related Art

When the projection technology used in handheld devices, small pictures displayed on display screens of the handheld devices may be projected onto projection screens, which may improve show of the pictures. However, the projection screens con not be controlled by different users using different handheld devices.

### BRIEF DESCRIPTION OF THE DRAWINGS

FIG. 1 is a block diagram of one embodiment of a projector device including a projection screen control system.

FIG. 2 is a block diagram of one embodiment of function modules of the projection screen control system in FIG. 1.

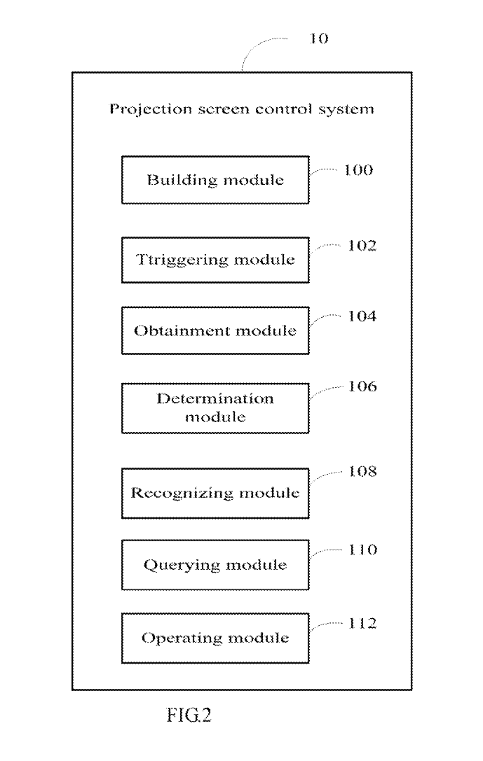

FIG. 3 is a flowchart of one embodiment of a method for controlling the projection screen.

FIG. 4 is one embodiment of a datasheet including a relationship between mouse icons and mouse operations.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

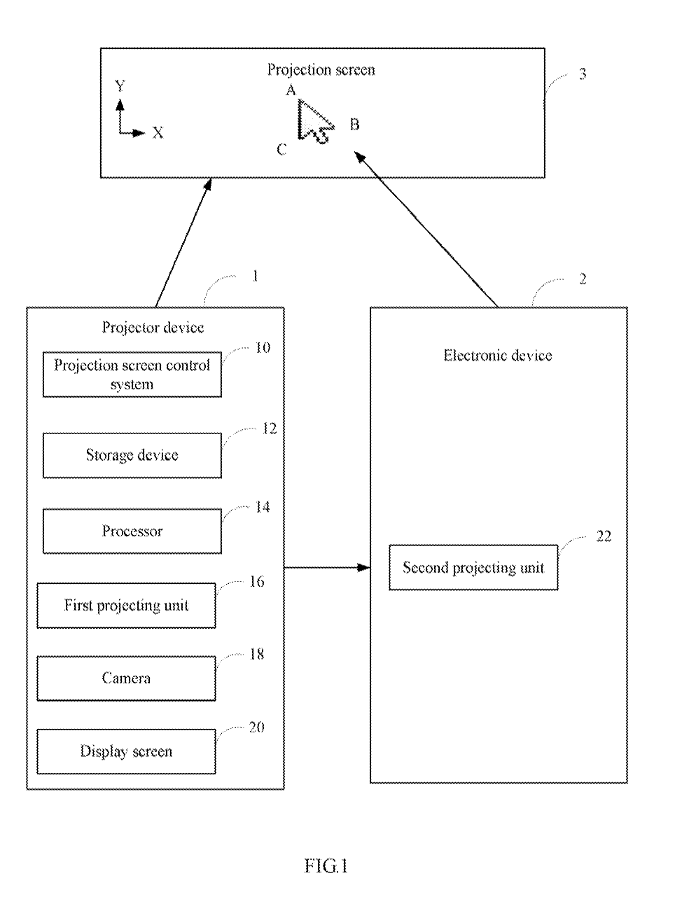

FIG. 1 is a block diagram of one embodiment of a projector device 1 including a projection screen control system 10. In the embodiment, the projector device 1 communicates with an electronic device 2, and may further comprise a storage device 12, at least one processor 14, a first projecting unit 16, a camera 18, and a display screen 20. The electronic device 2 may comprises a second projecting unit 22. The electronic device 2 may be a smart phone, a PDA device, or a tablet computer, for example.

In one embodiment, the storage device 12 (non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

The first projecting unit 16 projects a user interface displayed on the display screen 20 of the projector device 1 onto a projection screen 3. The projection screen 3 is used for displaying projected user interface for view of audiences. The second projecting unit 22 projects a mouse icon (or other cursor indicator) from the electronic device 2 onto the projection screen 3.

The camera 18 captures an image of the projection screen 3 if the mouse icon is projected onto the projection screen 3 by the second projecting unit 22.

In one embodiment, the projection screen controlling system 10 includes a plurality of function modules which include computerized codes or instructions that can be stored in the storage device 12 and executed by the at least one processor 14 to provide a method for controlling a projection screen.

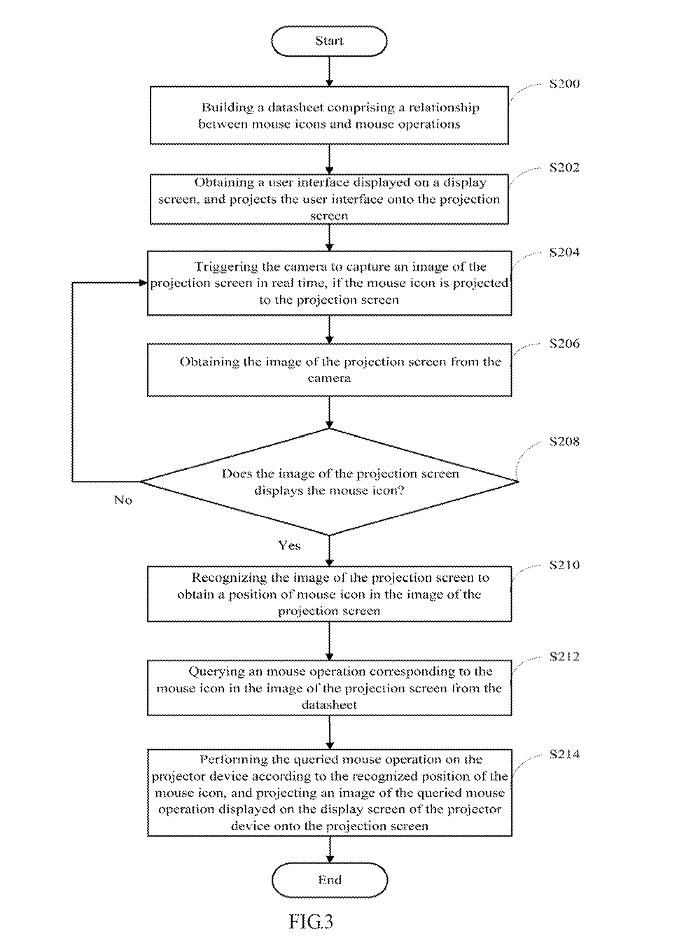

In one embodiment, the projection screen control system 10 may include a building module 100, a triggering module 102, a obtainment module 104, a determination module 106, a recognizing module 108, a querying module 110, and an operating module 112. The modules may comprise computerized codes in the form of one or more programs that are stored in the storage device 12 and executed by the at least one processor 14 to provide functions for implementing the modules. The functions of the function modules 100-112 are illustrated in FIG. 3 and described below.

FIG. 3 illustrates a flowchart of one embodiment of a method for controlling a projection screen using the projector device 1. Depending on the embodiment, additional steps may be added, others removed, and the ordering of the steps may be changed.

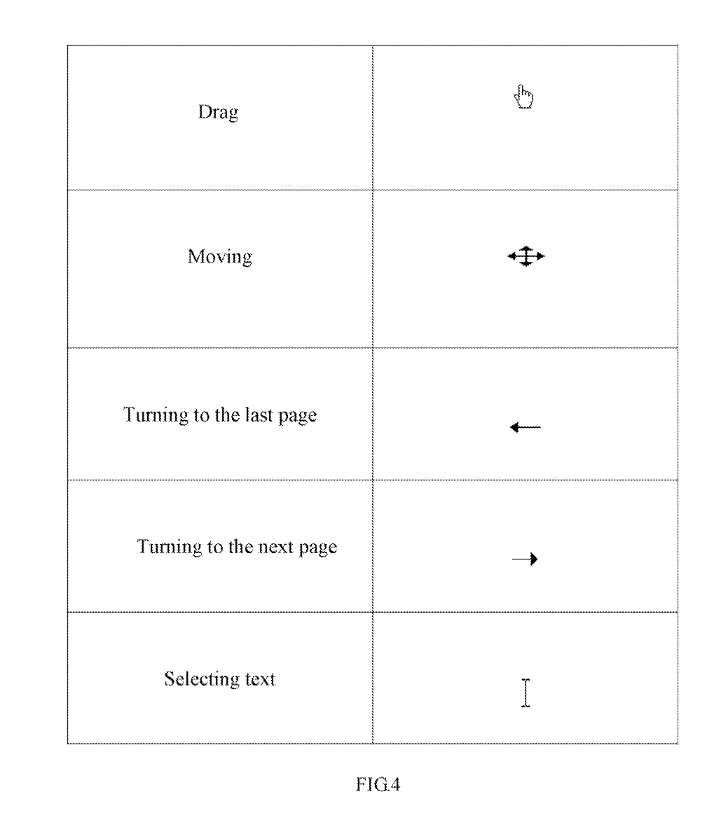

In block S200, the building module 100 builds a datasheet comprising a relationship between a mouse icon displayed on the display screen 20 and a mouse operation of a mouse or other indicator devices. Referring to FIG. 4, for example, if the mouse operation on the display screen 20 is a drag operation, the mouse icon may be a small hand shape displayed on the display screen 20. If the mouse operation is a turn pages operation, the mouse icon may be a left arrow or a right arrow displayed on the display screen 20.

In block S202, the first projecting unit 16 obtains the user interface displayed on the display screen 20, and projects the user interface onto the projection screen 3.

In block S204, the triggering module 102 triggers the camera 18 to capture an image of the projection screen 3 in real time, if the mouse icon is projected onto the projection screen 3. The mouse icon is stored in the electronic device 2 and is projected by the second projecting unit 12 of the electronic device 2.

In block S206, the obtainment module 104 obtains the image of the projection screen 3 from the camera 18.

In block S208, the determination module 106 determines whether the image of the projection screen 3 displays the mouse icon. In the embodiment, he Open Source Computer Vision Library (Open CV) is used to recognize the image of the projection screen 3 to determine whether the image of the projection screen 3 comprises the mouse icon. If the image of the projection screen 3 displays the mouse icon, block S210 is implemented. Otherwise, if the image of the projection screen 3 does not display the mouse icon, the flow returns to the block S204.

In block S210, the recognizing module 108 recognizes the image of the projection screen 3 to obtain a position of mouse icon in the image of the projection screen 3. In the embodiment, the positions of the mouse icon may be obtained by analyzing coordinate of vertexes (for example, A, B, C as shown in the FIG. 1) and a center point of the mouse icon according to a two-dimensional coordinate system(as shown in FIG. 1). The two-dimensional coordinate system is built by an origin point of an upper-left corner of the image of the projection screen 3.

In block S212, the querying module 110 queries a mouse operation of the mouse icon in the image of the projection screen 3 from the datasheet.

In block S214, the operating module 112 performs the queried mouse operation on the display screen 20 according to the recognized position of the mouse icon, and projects an image of the queried mouse operation displayed on the display screen 2 to the projection screen 3, making the projection screen 3 just like be controlled by the electronic device 2.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A projector device, comprising:
a first projecting unit;
a camera;
at least one processor;
a display screen; and
one or more programs stored in a storage device and executed by the at least one processor, the one or more programs comprising:
a building module that builds a datasheet comprising a relationship between a mouse icon displayed on the display screen and a mouse operation;
a triggering module that triggers the camera to capture an image of the projection screen comprising a user interface projected from the projector device when the mouse icon is projected onto the projection screen by a second projecting unit of an electronic device;
an obtainment module that obtains the image of the projection screen from the camera;
a recognizing module that recognizes the image of the projection screen to obtain a position of the mouse icon, if the image of the projection screen displays the mouse icon;
a querying module that queries a mouse operation of the mouse icon in the image of the projection screen from the datasheet; and
an operating module that performs the queried mouse operation on the display screen according to the obtained position of the mouse icon, and projects an image of the mouse operation onto the projection screen.

2. The projector device according to claim 1, wherein the position of the mouse icon is obtained by recognizing coordinates of vertexes and a center point of the mouse icon according to a two-dimensional coordinate system.

3. The projector device according to claim 2, wherein the two-dimensional coordinate system is created according to an origin point of an upper-left corner of the image of the projection screen.

4. The projector device according to claim 1, wherein the mouse icon is a small hand shape if the mouse operation is drag, and the mouse icon is a left arrow or a right arrow if the mouse operation is turn pages.

5. A method for controlling a projection screen using a projector device, the method comprising:
building a datasheet comprising a relationship between a mouse icon displayed on the display screen and a mouse operation;
triggering a camera of the projector device to capture an image of the projection screen comprising a user interface projected from the projector device when the mouse icon is projected onto the projection screen by a second projecting unit of an electronic device;
obtaining the image of the projection screen from the camera;
recognizing the image of the projection screen to obtain a position of the mouse icon, if the image of the projection screen displays the mouse icon;
querying a mouse operation of the mouse icon in the image of the projection screen from the datasheet; and
performing the queried mouse operation on the display screen according to the obtained position of the mouse icon, and projecting an image of the mouse operation onto the projection screen.

6. The method according to claim 5, wherein the position of the mouse icon is obtained by recognizing coordinates of vertexes and a center point of the mouse icon according to a two-dimensional coordinate system.

7. The method according to claim 6, wherein the two-dimensional coordinate system is created according to an origin point of an upper-left corner of the image of the projection screen.

8. The method according to claim 5, wherein the mouse icon is a small hand shape if the mouse operation is drag, and the mouse icon is a left arrow or a right arrow if the mouse operation is turn pages.

9. A non-transitory computer-readable storage medium having stored thereon instructions being executed by a processor of a projector device, causes the projector device to perform a method for controlling a projection screen, the method comprising:
building a datasheet comprising a relationship between a mouse icon displayed on the display screen and a mouse operation;
triggering a camera of the projector device to capture an image of the projection screen comprising a user interface projected from the projector device in real time when the mouse icon is projected onto the projection screen by a second projecting unit of an electronic device;
obtaining the image of the projection screen from the camera;
recognizing the image of the projection screen to obtain a position of the mouse icon, if the image of the projection screen displays the mouse icon;
querying a mouse operation of the mouse icon in the image of the projection screen from the datasheet; and
performing the queried mouse operation on the display screen according to the obtained position of the mouse icon, and projecting an image of the mouse operation onto the projection screen.

10. The storage medium according to claim 9, wherein the position of the mouse icon is obtained by recognizing coordinates of vertexes and a center point of the mouse icon according to a two-dimensional coordinate system.

11. The storage medium according to claim 10, wherein the two-dimensional coordinate system is created according to an origin point of an upper-left corner of the image of the projection screen.

12. The storage medium according to claim 9, wherein the mouse icon is a small hand shape if the mouse operation is drag, and the mouse icon is a left arrow or a right arrow if the mouse operation is turn pages.
